(19) United States
(12) Patent Application Publication
(10) Pub. No.: US 2016/0227801 A1
(43) Pub. Date: Aug. 11, 2016

(54) EDIBLE EMULSION COATING FOR EXTENDED SHELF LIFE

(71) Applicant: National Pasteurized Eggs, Inc., Lansing, IL (US)

(72) Inventor: Hector Gregorio Lara, Plainfield, IL (US)

(73) Assignee: National Pasteurized Eggs, Inc., Lansing, IL (US)

(21) Appl. No.: 15/014,353

(22) Filed: Feb. 3, 2016

Related U.S. Application Data
(60) Provisional application No. 62/114,310, filed on Feb. 10, 2015.

(51) Int. Cl. A23B 5/06; A23B 5/005

(52) U.S. Cl. CPC A23B 5/06; A23B 5/0052; A23V 2002/00

(57) ABSTRACT

An edible, aqueous emulsion coating is particularly suitable for coating washed or pasteurized chicken shell eggs to extend shelf life in high humidity climates. The edible, aqueous emulsion coating includes paraffin and carnauba wax as well as hydrophobic means for maintaining the integrity of the dried, emulsion coating over the entire surface of the shell of the chicken egg even when the coated chicken egg is in humid environments having a dew point exceeding 85° F. A suitable hydrophobic means is high-density, food-grade polyethylene.

### FIELD OF THE INVENTION

The invention relates to an edible emulsion coating particularly well adapted to be applied to shell eggs that have been washed or pasteurized. Application of the edible emulsion coating provides improved shelf life even in humid environments.

### BACKGROUND OF THE INVENTION

Current commercially pasteurized eggs involve placing the eggs in a heated water bath for a long enough time to achieve a 5-log kill of Salmonella Enteriditis throughout the entire egg including the yolk and the albumen. Methods for pasteurizing eggs are described in, for example, U.S. Pat. No. 6,165,538 entitled “Pasteurized In-Shell Chicken Eggs”, by Leon John Davidson, issuing on Dec. 26, 2000 and U.S. Patent Publication Application No. 2011/0300023A1, entitled “Shell Egg Pasteurization System and Method”, by Hector Gregorio Apolinar Lara Plascencia, et al., published on Dec. 8, 2011. The disclosure of both of these patents is incorporated by reference herein. The processing of the shell eggs downstream of the pasteurization bath involves spraying the eggs with an anti-bacterial agent, spraying a heated, aqueous emulsion wax coating on the eggs, drying the coating and printing a mark on the eggs to indicate that they have been pasteurized prior to packaging in cartons or on flats.

It is known to coat the shell of washed or pasteurized chicken shell eggs with an edible coating containing wax, oil, protein, or a variety of other edible ingredients in order to seal the pores in the shell and maintain freshness and quality, and extend the shelf life of the egg.

A chicken egg is composed of three main parts: the shell, the albumen (egg white) and the yolk. Egg shells contain a large number of pores that allow for the permeation of water and gases. A cuticle on the outer surface of the shell protects the egg from moisture loss and invasion of microorganisms to a certain extent but is easily removed when the eggs are washed. Shell eggs are susceptible to internal quality deterioration and microbial contamination since the moment that they are laid. During storage, the albumen tends to thin and air cell tends to grow due to water loss. Carbon dioxide migration through the egg shell can lead to increased albumen pH and decreased yolk strength. Moreover, bacteria can penetrate the egg shell and cause spoilage.

Low temperature refrigeration is considered the most important treatment for preserving eggs, for example refrigerating at 45° F. or below. Coating the shells is another way to preserve the internal quality of the eggs. Coatings act as a barrier for moisture and gas and help prevent the penetration of bacteria or other microorganisms into the interior of the eggs. Various edible waxes or oil coatings or other types of coatings have been used in the past. One common way to coat the eggs is to spray a heated, aqueous wax emulsion on the eggs as the eggs all move and are rotated on a conveyor. In such a system, nozzles spray a mist of a heated wax emulsion solution downward on the eggs as they pass under the spray bar. The conveyor rotates the eggs as the eggs pass through the mist to ensure that the entire surface of the shell is covered by the coating. The eggs are then passed through a drying station prior to packaging.

One emulsion coating used on shell eggs is an organic emulsion containing paraffin wax and carnauba wax. This combination when dried has been shown to provide a reliable protective coating over the shell, and to also provide a semi-glossy finish that is commercially desirable. The finish not only preserves the freshness of the egg and increases shelf life but also helps to maintain its safeness. The paraffin-carnauba emulsion requires an emulsifying agent such as morpholine oleate or other surfactant approved by the FDA for use in food coatings. The emulsion is diluted with water, heated to about 160° F. or above and sprayed onto the eggs as a mist.

As mentioned, the use of such paraffin-carnauba emulsion coatings has been found to effectively maintain overall product freshness and extend shelf life in many commercial applications, especially when combined with proper refrigeration. With proper refrigeration, coated pasteurized shell eggs will normally have shelf life exceeding 60 days or even 90 days from the date of pasteurization. The inventors have discovered, however, that the wax coating can over time release in extremely humid environments (e.g., dew point at or above 85° F.). In these extremely humid environments, it is believed that the dried emulsion coating absorbs water from the humid environment, which in turn changes the rheology of the wax coating and allows it to release and migrate over the surface of the egg. It is believed that the pores in some portions of the egg may absorb some of the wax coating, thus leaving other areas on the surface of the eggshell without coverage. Open pores in the uncovered areas may allow bacteria into the egg, and otherwise tend to reduce freshness and overall shelf life.

### SUMMARY OF THE INVENTION

The invention is directed to an edible, aqueous emulsion coating including paraffin wax and carnauba wax as well as hydrophobic means for maintaining the integrity of the dried, emulsion coating over the entire surface of the shell of the chicken egg even when the coated chicken egg is in humid environments having a dew point exceeding 85° F. The exemplary hydrophobic means is high-density, food-grade polyethylene. The aqueous emulsion with paraffin wax, carnauba wax and high-density polyethylene is food safe, and has been found to be stable in very humid environments when typical paraffin-carnauba organic wax emulsions are not stable. The high-density polyethylene is hydrophobic and provides film hardness and structural integrity even in extremely humid conditions. It is important, however, that not too much high-density polyethylene be added to the overall mixture as crazing or cracking of the coating can occur if too much high-density polyethylene is used.

The aqueous emulsion with high-density polyethylene is particularly well suited for coating washed or pasteurized eggs that are expected to be distributed and/or stored in humid tropical environments and climates. The aqueous emulsion will typically be heated, diluted and spray coated onto the egg shells in the same manner as described above with the paraffin-carnauba wax emulsion. Desirably, the concentrate for the diluted emulsion coating is a mixture of a paraffin-carnauba emulsion and an anionic polyethylene emulsion, with the preferred ingredient ranges being about 70-80% of the paraffin-carnauba emulsion comprising the following constituents, water 60-70% by weight, paraffin wax 15-20% by weight, carnauba wax 5-20% by weight, emulsification agents 5-25% by weight and about 20-30% anionic polyethylene emulsion consisting of 70-75% by weight water, 20-25% by weight oxidized ethene homopolymer and 5-10% by weight emulsification agents.

Testing has shown that the use of the paraffin-carnauba emulsion with high-density polyethylene provides stable, reliable coatings for eggs even in high humidity applications. Testing also shows improved shelf life of pasteurized eggs in high humidity applications. Further, testing on pasteurized eggs treated with the coating in high humidity applications has shown virtually no bacteria growth.

The coating can be used for other applications as well, for example, such as a humectant for flowers.

### BRIEF DESCRIPTION OF THE DRAWINGS

FIG. 1 is a flow chart illustrating the processing of pasteurized eggs prior to shipping.

### DETAILED DESCRIPTION

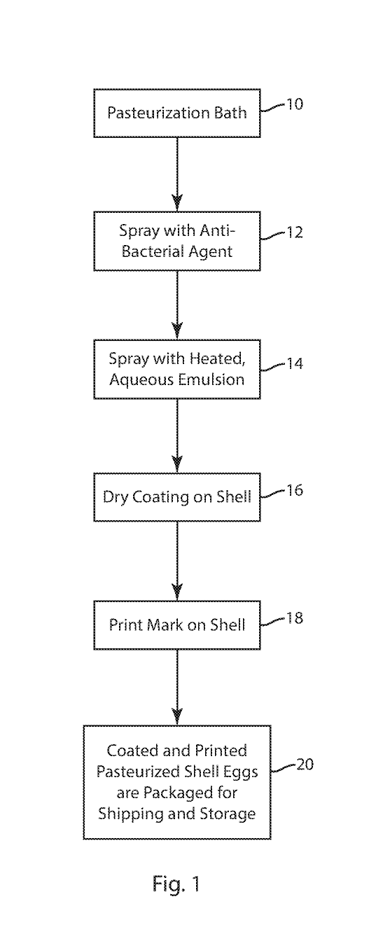

Referring to FIG. 1, the most common, commercial shell egg pasteurization process involves the placing of shell eggs in a heated water bath, block 10, for a sufficient amount of time to achieve the desired log kill of Salmonella or other bacteria. The US FDA requires that the heat treatment in the water bath be sufficient to achieve a 5-log kill of Salmonella Enteriditis. The above incorporated U.S. Pat. No. 6,165,538 entitled “Pasteurized In-Shell Chicken Eggs”, by Leon John Davidson, issuing on Dec. 26, 2000 and U.S. Patent Publication Application No. 2011/0300023A1, application Ser. No. 12/792,409, entitled “Shell Egg Pasteurization System and Method”, by Hector Gregorio Apolinar Lara Plascencia, et al., published on Dec. 8, 2011 (the “Lara '409 application”), describe thermal treatments sufficient to achieve a 5-log kill of Salmonella Enteritidis in chicken shell eggs and should be consulted for a more complete understanding of the water bath pasteurization process. U.S. Pat. No. 6,113,961, entitled “Apparatuses and Methods for Pasteurizing In-Shell Eggs,” to Louis Polster and the above incorporated Lara '409 application describe that is possible to stack the shell eggs in a water bath and still achieve uniform heat treatment and pasteurization. The Lara '409 application also describes methods for accurately controlling the temperature of the water bath to ensure uniform heat treatment and pasteurization from batch to batch.

When the batches of pasteurized eggs are removed from the heated water bath 10, they are placed on a conveyor that is designed to rotate the eggs as it transports them. The first step of processing along the conveyor involves spraying the eggs with antibacterial agent, see block 12, such as diluted quaternary ammonium. Next, the shell eggs are sprayed with a heated, aqueous emulsion coating, see block 14. A sprayer having multiple nozzles sprays diluted emulsion downward on the egg as the eggs pass through the sprayer. The wax emulsion concentrate is diluted with water, for example 8:1, prior to filling the sprayer tank and heating the emulsion. The diluted emulsion is maintained about 160° F. or above in order to ensure proper application and coverage of the paraffin and carnauba wax and high-density polyethylene constituents. The shell of the eggs is approximately 110° F. when the diluted wax emulsion is sprayed on the shell. After spraying, the coated eggs enter a drying station, block 16, in which ambient air is blown over the coated eggs to dry the coating. Next, the shells are printed with a mark, see block 18, in order to identify the eggs as being pasteurized. After printing, the coated and pasteurized shell eggs are packaged and stored for shipping and distribution as indicated by block 20.

In most environments, the emulsion coating based on paraffin and carnauba waxes is more than sufficient.

Acceptable shelf lives for refrigerated shell eggs are in the range of 60 days and more preferably 90 days. It was discovered, however, that the shelf life of pasteurized eggs in tropical environments and other environments having high humidity was compromised significantly even when the pasteurized eggs were coated with a paraffin-carnauba wax coating. Refrigeration helps to maintain longer shelf lives but in many tropical areas consumers do not refrigerate or the refrigeration is not as high quality as in the United States. After investigating possible reasons for compromised shelf life in tropical regions, it was hypothesized that the integrity of the wax coating may be compromised after the eggs are packaged and/or shipped, thus leading to poor shelf lives. It was determined that the paraffin-carnauba wax coating draws water from the humid environment thereby allowing the coating over time to release and creep or flow over the shell of the egg. As time passed, some areas of the shell, for example the area near the air sack, tends to draw in the compromised wax coating through the pores of the egg which in turn eliminates coverage of the coating over other portions of the egg shell. It was found that adding food-grade, high-density polyethylene to the wax emulsion provided structural integrity to the coating even in tropical and other very humid environments.

Tables 1A through 1C contain data for shelf life tests comparing pasteurized eggs with shells coated with the inventive coating under various environmental conditions to unpasteurized, uncoated control eggs. More specifically, Tables 1A through 1C contain data for shelf life tests comparing pasteurized eggs having the shell coated with the heated, aqueous emulsion including paraffin, carnauba and high-density polyethylene to unpasteurized, uncoated control eggs, with the pasteurized eggs being refrigerated at or below 45° F. (Table 1A), the pasteurized eggs being stored at an air conditioned 72° F. (Table 1B), and the pasteurized eggs being held in an environment with a high humidity and temperature above 80° F. (Table 1C).

TABLE 1A
Refrigerated Room <45° F.

| | | | Pasteurized | | Control | |
|---|---|---|---|---|---|---|
| Day | Tests | Unit | Egg white | Egg yolk | Egg white | Egg yolk |
| 0 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 94 (AA) | | Haugh unit: 82(AA) | |
| 7 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 92 (AA) | | Haugh unit: 75 (AA) | |
| 14 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 98 (AA) | | Haugh unit: 72 (AA) | |
| 21 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 93 (AA) | | Haugh unit: 80 (AA) | |
| 28 | Aerobic Plate Count | CFU/g | <5000 | <5000 | <5000 | <5000 |
| | E Coli Count | CFU/g | <10 | <10 | 10 | <10 |
| | Enterobacteriaceae Count | CFU/g | <10 | <10 | 20 | <10 |
| | Salmonella spp. | /25 g | ND | ND | ND | ND |
| | Pseudomonas spp | /25 g | <100 | <100 | <100 | <100 |
| | Freshness | | Haugh unit: 93 (AA) | | Huagh unit: 71 (A) | |
| 35 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 94 (AA) | | Haugh unit: 76 (AA) | |
| 42 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 90 (AA) | | Haugh unit: 78 (AA) | |
| 49 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 92 (AA) | | Haugh unit: 71 (A) | |
| 56 | Aerobic Plate Count | CFU/g | 6.0 ± 10³ | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 94 (AA) | | Haugh unit: 68 (A) | |
| 63 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 92 (AA) | | Haugh unit: 66 (A) | |
| 70 | Aerobic Plate Count | CFU/g | 1.0 × 10⁴ | 5.4 × 10³ | 4.4 × 10³ | 6.2 × 10³ |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 89 (AA) | | Haugh unit: 65 (A) | |
| 77 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 92 (AA) | | Haugh unit: 72 (AA) | |
| 84 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 88 (AA) | | Haugh unit: 65 (A) | |
| 91 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 90 (AA) | | Haugh unit: 75 (AA) | |
| 98 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 90 (AA) | | Haugh unit: 43 (B) | |
| 105 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 81 (AA) | | Haugh unit: 53 (B) | |
| 112 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp. | /25 g | <100 | <100 | <100 | <100 |

| | | |
|---|---|---|
| Freshness | Haugh unit: 73 (AA) | Haugh unit: 65 (A) |

TABLE 1B
Air-Conditioned Room Temperature - 72° F.

| | | | Pasteurized | | Control | |
|---|---|---|---|---|---|---|
| Day | Tests | Unit | Egg white | Egg yolk | Egg white | Egg yolk |
| 0 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 96 (AA) | | Haugh unit: 80 (AA) | |
| 7 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 89 (AA) | | Haugh unit: 69 (A) | |
| 14 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 96 (AA) | | Haugh unit: 62 (A) | |
| 21 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 85 (AA) | | Haugh unit: 59 (B) | |
| 28 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 95 (AA) | | Haugh unit: 46 (B) | |
| 35 | Aerobic Plate Count | CFU/g | 5.2 × 10³ | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 82 (AA) | | Haugh unit: 41 (B) | |
| 42 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 71 (A) | | Haugh unit: 37 (B) | |
| 49 | Aerobic Plate Count | CFU/g | <5000 | 5.0 × 10³ | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 78 (AA) | | Haugh unit: 30 (B) | |
| 56 | Aerobic Plate Count | CFU/g | 7.6 × 10³ | 8.2 × 10³ | 6.8 × 10³ | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | 1.0 × 10² | <100 | <100 | <100 |

| | | |
|---|---|---|
| Freshness | Haugh unit: 73 (AA) | Haugh unit: 27 (B) |

TABLE 1C
Holding Room Temperature 80° F. or above

| | | | Pasteurized | | Control | |
|---|---|---|---|---|---|---|
| Day | Tests | Unit | Egg white | Egg yolk | Egg white | Egg yolk |
| 0 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 93 (AA) | | Haugh unit: 82 (AA) | |
| 7 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 92 (AA) | | Haugh unit: 62 (A) | |
| 14 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 85 (AA) | | Haugh unit: 54 (B) | |
| 21 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |
| | Freshness | | Haugh unit: 86 (AA) | | Haugh unit: 32 (B) | |
| 28 | Aerobic Plate Count | CFU/g | <5000 | <5000 | <5000 | <5000 |
| | E Coli Count | CFU/g | <10 | <10 | <10 | <10 |
| | Enterobacteriaceae Count | CFU/g | <10 | <10 | <10 | <10 |
| | Salmonella spp. | /25 g | ND | ND | ND | ND |
| | Pseudomonas spp | /25 g | <100 | <100 | <100 | <100 |

| | | |
|---|---|---|
| Freshness | Haugh unit: 74 (AA) | Haugh unit: 35 (B) |

The far left hand column in Tables 1A-1C indicates the number of days the samples were stored before being tested. The second and third columns indicate the pathogens that were tested for in weeks 0, 1 through 16. The tests include an aerobic plate count, an E coli count, Enterobacteriaceae count and Salmonella ssp., and Pseudomonas ssp., as well as a freshness test measured Haugh units. For each week, coated pasteurized eggs (“Pasteurized”) and uncoated, unpasteurized eggs (“Control”) were pulled and tested from three different climates. In the first climate (Table 1A), both the pasteurized and control eggs were stored in a refrigerated room at 45° F. or less. In the second climate (Table 1B), the pasteurized and control eggs were stored in an air conditioned room at 72° F. In the third climate (Table 1C), the pasteurized and control eggs were held in a room having a high humidity (dew point above 80° F.) and a temperature above 80° F. At Day 0, the data in Tables 1A through 1C shows virtually no contamination and the freshness of the eggs (measured in Haugh units) in all environments is at a Grade AA level for both pasteurized and control eggs. The end of edible shelf life is normally defined as 10,000,000 bacteria count per gram. All the eggs tested in Tables 1A through 1C satisfied the 10,000,000 bacteria count per gram threshold, although it the data indicates that the shelf life was nearing its end. Note that Salmonella was not detected in any of the eggs at any time during the testing.

Referring to Table 1C where the pasteurized and control eggs were held in a humid environment and at a room temperature of 80° F. or above, it can be seen that the Haugh units for the control eggs degrade much faster than the Haugh units for the coated, pasteurized eggs. In fact, at Day 14 the Haugh units for uncoated control eggs had decreased to a value of 54 which is considered Grade B. Testing ended at 28 days in the warm, humid climate with the measured Haugh units for the coated pasteurized eggs still being Grade AA and the freshness of the control eggs being roughly 35 Haugh units. Turning to testing in the air conditioned, relatively low humidity climate held at 72° F. (Table 1B), it can be seen that the freshness, measured in Haugh units, of the coated pasteurized eggs remained relatively high, namely Grade AA or Grade A, through testing Day 56. On the other hand, the freshness of the uncoated control eggs began to deteriorate to Grade B after 21 days, and was severely compromised by 56 days (measured Haugh unit 27). Turning now to Table 1B in which the test eggs were held in a refrigerated room at 45° F. or below, it can be seen that the freshness as measured in Haugh units for the coated pasteurized eggs remained Grade AA throughout the entire test which ended after 112 days. On the other hand, the Haugh units for the refrigerated control eggs began to decline to Grade A at Day 49 and showed some irregularity through Day 90 of testing, and were low Grade A or Grade B thereafter.

The results in Tables 1A through 1C show that the shelf life under tropical conditions for pasteurized shell eggs coated with the paraffin-carnauba emulsion with high-density polyethylene is much better than the unpasteurized, uncoated control eggs. The results also show that, even in an air conditioned room at 72° F., the coated pasteurized eggs performed much better in terms of shelf life than the unpasteurized, uncoated control eggs. Finally, even under refrigerated conditions, the coated pasteurized eggs maintained freshness measured in Haugh units longer than the uncoated, unpasteurized control eggs.

The formulation for the concentrate of the edible, aqueous emulsion used in the testing of Tables 1A through 1C is a combination of a paraffin-carnauba emulsion constituent and an anionic polyethylene emulsion constituent. The paraffin-carnauba emulsion constituent comprises about 60-70% by weight water, 15-25% by weight paraffin wax, 5-20% by weight carnauba wax, 5-15% by weight morpholine oleate and 1-10% by weight sodium lauryl sulfate. The morpholine oleate and the sodium lauryl sulfate are emulsifying agents. The anionic polyethylene emulsion constituent comprises about 70-75% by weight water, 20-25% by weight oxidized ethene homopolymer, and about 5-10% by weight morpholine oleate. The emulsion contains about 80-70% by weight of the paraffin-carnauba emulsion constituent and about 20-30% by weight of the anionic polyethylene emulsion constituent. As mentioned, the concentrate is diluted with water (e.g., 8:1) and heated (above about 160° F.) prior to spray coating on the food product.

The formulation with paraffin wax, carnauba wax and high-density polyethylene is applied in the same manner as the formulation with the paraffin wax and the carnauba wax and can be used not only in tropical environments having high humidity but in other environments having high humidity or even in environments having low humidity. In addition, the formulation can be used for other applications, such as for other food applications or as a humectant for flowers.

In the foregoing description, certain terms have been used for brevity, clarity, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

What is claimed is:

1. A coated chicken egg comprising:
a chicken egg having a shell with an outer surface; and
a dried, edible emulsion coating covering the outer surface of the chicken egg, said emulsion coating, comprising, when applied an aqueous emulsion including paraffin wax, carnauba wax, and high-density polyethylene;
wherein the high-density polyethylene in the dried coating is hydrophobic in humid environments having a dew point exceeding 85° F.

2. A coated chicken egg as recited in claim 1 wherein the chicken egg is a pasteurized chicken egg.

3. A coated chicken egg as recited in claim 1 wherein the aqueous emulsion further comprises an emulsifying agent.

4. A coated chicken egg as recited in claim 1 wherein the dried emulsion coating comprises the following relative weights of paraffin wax, carnauba wax and high-density polyethylene: about 8.5-20.0 gm/100 gm of paraffin wax, about 3.5-16.0 gm/100 gm of carnauba wax, and about 4.0-7.5 gm/100 gm of high-density polyethylene.

5. A coated chicken egg as recited in claim 1 wherein the chicken egg is pasteurized prior to being coated such that the chicken egg has been treated sufficiently to achieve a 5 log kill of Salmonella Enteritidis throughout the mass of the egg including the yolk.

6. A concentrate for an edible, aqueous emulsion coating for a food product comprising:
a combination of a paraffin-carnauba emulsion constituent and an anionic polyethylene emulsion constituent, said paraffin-carnauba emulsion constituent comprising:
about 60-70% by weight water, 15-25% by weight paraffin wax, 5-20% by weight carnauba wax, 5-15% by weight morpholine oleate and 1-10% by weight sodium lauryl sulfate; and
said anionic polyethylene emulsion constituents comprising:
70-75% by weight water, 20-25% by weight oxidized ethene homopolymer, and about 5-10% by weight morpholine oleate; and
wherein said concentrate contains about 80-70% by weight of the paraffin emulsion constituents and about 20-30% by weight of the anionic polyethylene emulsion constituents, and said concentrate is diluted with water prior to spray coating on the food product.

7. A method of pasteurizing a chicken shell egg comprising:
placing the chicken shell egg in a heated water bath for a time sufficient to achieve a 5-log kill of Salmonella Enteritidis throughout the mass of the egg including the yolk;
removing the chicken shell egg from the heated water bath;
treating the surface of the shell egg with an anti-bacterial agent;
spraying a heated, aqueous wax emulsion coating on the entire surface of the shell of the chicken shell egg, said aqueous wax emulsion comprising paraffin wax, carnauba wax, high-density polyethylene and one or more emulsification agents;
drying the sprayed aqueous was emulsion coating on the shell eggs;
printing a mark on each shell eggs indicating that the egg has been pasteurized; and
packaging the coated shell eggs for storage, shipping and distribution.

8. A method of pasteurizing a chicken shell egg as recited in claim 7 wherein said aqueous, wax emulsion sprayed onto the shell of the chicken egg comprises water-diluted concentrate, said concentrate comprising a combination of a paraffin-carnauba emulsion constituent and an anionic polyethylene emulsion constituent, the paraffin-carnauba emulsion constituent comprising about 60-70% by weight water, 15-25% by weight paraffin wax, 5-20% by weight carnauba wax, 5-15% morpholine oleate and 1-10% sodium lauryl sulfate, and the anionic polyethylene emulsion constituent comprising about 70-75% water, 20-25% by weight oxidized ethene homopolymer, and about 5-10% by weight morpholine oleate, said concentrate containing between about 70-80% by weight of the paraffin-carnauba emulsion constituent and about 20-30% by weight of the anionic polyethylene emulsion constituent.

9. A method of pasteurizing a chicken shell egg as recited in claim 7 wherein the shell egg is loaded onto a conveyor that rotates the shell egg at least during the time that the aqueous, wax emulsion coating is sprayed on the entire surface of the shell of the chicken shell egg.

10. A coated chicken egg comprising:
a chicken egg having a shell with an outer surface; and
a dried, edible emulsion coating covering the outer surface of the chicken egg, said emulsion coating comprising, when applied, an aqueous emulsion comprising paraffin wax, carnauba wax, and hydrophobic means for maintaining the integrity of the emulsion coating when dried over the entire surface of the shell of the chicken egg even when the coated chicken egg is in humid environments having a dew point exceeding 85° F.

11. A coated chicken egg as recited in claim 10 wherein the chicken egg is a pasteurized chicken egg.

12. A coated chicken egg as recited in claim 11 wherein the chicken egg is pasteurized prior to being coated such that the chicken egg has been treated sufficiently to achieve a 5 log kill of Salmonella Enteritidis throughout the mass of the egg including the yolk.

13. A coated chicken egg as recited in claim 10 wherein the aqueous emulsion further comprises an emulsifying agent.
